(19) United States
(12) Patent Application Publication
(10) Pub. No.: US 2005/0190043 A1
(43) Pub. Date: Sep. 1, 2005

(54) Tag mounting method and tagged vehicle component

(75) Inventor: Toshio Yamagiwa, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/052,363

(22) Filed: Feb. 7, 2005

(30) Foreign Application Priority Data
Feb. 26, 2004 (JP) 2004-051569

(51) Int. Cl. B32B 31/00

(52) U.S. Cl. 340/425.5; 156/275.5; 156/293; 40/630

(57) ABSTRACT

A method of applying a radio-frequency integrated circuit (IC) ID tag to a metal component within a device is described. In the method, a recessed portion is provided on a metal component such as a wheel. An IC tag storing information about the component (the wheel) or the device as a whole (for example, a motorcycle) is buried in this recessed portion, and is sealed therein by applying adhesive resin to completely cover the entire IC tag. A signal-absorbing material may be provided between the IC tag and the recess floor to prevent reflection from the metal surface of a transmitted radio wave. The tag mounting method allows a secure fit of a tag storing information about an article to a metal component, resulting in a tagged metal component.

### CROSS-REFERENCE TO RELATED APPLICATIONS

The present invention claims priority under 35 USC 119 based on Japanese patent application No. 2004-051569, filed on Feb. 26, 2004. The subject matter of the referenced priority document is incorporated by reference herein.

### BACKGROUND OF THE INVENTION

1. Field of the Invention

The present invention relates to a tag mounting method of securing a tag to a metal component which is used to form an article, and to a metal component tagged using the method, in which the tag stores information about the article.

2. Description of the Background Art

Theft of an article can be detected using a theft detection device. In merchandise management, use of theft detection devices is well known. For example, according to Japanese Unexamined Patent Publication No. 5(1993)-221352, an ID tag is sealed in an auto body component such as a fuel lid. Car model information is obtained by reading the car model information stored in the ID tag with a non-contact sensor, or reader, at the time of vehicle production and after the vehicle is shipped.

The above-described sensor, or reader, outputs a radio wave at a resonance frequency to the tag. A transponder provided inside the tag receives, and resonates with, the radio wave, and then notifies the sensor of detection of a theft. The radio wave transmitted and received herein is not obstructed or interfered with by the existence of plastics. Accordingly, no reading errors occur when the ID tag is buried in a resin molded item such as a fuel lid.

On the other hand, a metal region in the article is inherently high in strength, which is an advantage for securing the tag thereon. However, if the tag is enclosed inside of a metal component, the metal component reflects the radio wave back toward the reader. Accordingly, there is a possibility that the radio wave emitted from the tag may be weakened, or that a reading error could occur on the sensor side.

The present invention has been made in consideration of the foregoing circumstance, and a first object thereof is to provide an ID tag mounting method and a tagged metal component capable of achieving good transmission and reception while securely mounting an ID tag, which stores information about an article, to a high-strength metal component.

Moreover, a second object of the present invention is to provide a method of mounting a tag to a metal component, and a tagged metal component capable of consistently and accurately transmitting information from an ID tag which stores the information about an article.

### SUMMARY OF THE INVENTION

In a first exemplary embodiment thereof, the present invention provides a method of mounting a tag (such as a radio frequency integrated circuit (IC) tag), which stores information about an article, to a metal component used to form the article. The method of mounting a tag is characterized in that a recessed portion is provided on the metal component. The recessed portion is formed in the surface of the component so as to open toward the outside. The tag is placed in the recessed portion, and the entire tag is substantially covered by resin so as to be sealed by, and buried within the resin within the recessed portion.

By the configuration described above, the tag is mounted to the metal component so as to be located in the recessed portion and sealed in place by the resin. Meanwhile, a read/write signal sent to the tag is easily transmitted through the resin, and is received by the tag.

Moreover, in a second embodiment thereof, the present invention is characterized in that a signal-absorbing material is buried in the recessed portion. An example of such a material includes, but is not limited to a glass-epoxy composite. Subsequently, the tag is buried on the signal-absorbing material and sealed by the resin in such a manner that the entire tag is substantially completely covered.

By the configuration described above, the IC tag is mounted to the metal component so as to be placed on the signal-absorbing material inside the recessed portion and sealed by the resin from above. Meanwhile, the read/write signal sent to the IC tag is transmitted through the resin and is received by the IC tag, and is absorbed by the signal-absorbing material.

Moreover, in another embodiment thereof, the present invention provides a tagged metal component having a buried tag storing information about an article constituted by the metal component, which is characterized in that the metal component includes a recessed portion, then the tag is buried in the recessed portion and sealed in place by resin, and the entire tag is substantially completely covered.

Moreover, still another embodiment of the present invention provides a vehicle to which an IC tag is mounted, the IC tag storing given vehicle information. The vehicle is characterized in that the IC tag is placed on an adhesive attached onto a car body of the vehicle, and is sealed thereon by resin. In this manner, the entire IC tag, together with the adhesive, are substantially completely covered.

By the configuration described above, the IC tag is substantially entirely covered with the resin, and together with the adhesive is attached onto the body of the vehicle. Meanwhile, a read/write signal (an electromagnetic wave) sent to the IC tag is easily transmitted through the resin member and is received by the IC tag.

In a further embodiment thereof, the present invention is characterized in that the resin is UV setting resin, which is curable on exposure to ultraviolet light.

By the configuration described above, when the IC tag is irradiated with ultraviolet rays while entirely covered with the resin, the UV setting resin hardens together with the IC tag and the adhesive. By this mechanism, the IC tag and the adhesive are thereby more firmly attached onto the vehicle body.

Moreover, in another embodiment, the present invention is characterized in that the recessed portion is provided on a surface of a front wheel rim adjacent to a hub.

By the configuration described above, it is possible to check air pressure of a front tire and to read data simultaneously.

Moreover, in another embodiment, the present invention is characterized in that the recessed portion is provided on a side of a main vehicle body frame so as to be exposed to the outside of the vehicle.

By the configuration described above, it is easy to read the data. For example, in the case of a motorcycle having a twin-tube frame or the like, it is easy to read the data because the frame is exposed to the outside.

Moreover, in another embodiment, the present invention is characterized in that the recessed portion is provided on a tandem step bracket on a side of the vehicle.

By the configuration described above, it is easy to read the data. For example, in the case of a motorcycle having a tandem step, it is easy to read the data because a tandem step is exposed to the side of the vehicle.

Further, in another embodiment, the present invention is characterized in that the recessed portion is provided on a head cover of an engine mounted on the vehicle in an upright state.

By the configuration described above, the IC tag is buried within a recess formed within a head cover, particularly in the upper head cover, of the engine. Accordingly, it is easy to read the data and, in case of a trouble, it is possible to perform maintenance of the IC tag simply by detaching the head cover.

As described above, according to the present invention, the IC tag, together with the adhesive, attached onto the body of the vehicle and entirely covered with the resin. Meanwhile, the read/write signal (the electromagnetic wave) to the IC tag is transmitted through the resin member and is received. Therefore, durability and reliability of the IC tag is improved by means of covering with the resin while maintaining the IC tag in a readable and writable state.

Moreover, according to the present invention, the IC tag receives the read/write signal transmitted from an IC tag reader, writes to a memory in the IC tag or reads from the given vehicle information written in the memory, and transmits the vehicle information thus read out on a radio wave. Therefore, it is possible to achieve reading and writing of vehicle information by using radio transmission. In particular, it is easy to mount the IC tag to a lower part of a body of a two-wheel vehicle or a four-wheel vehicle, or the like, and to facilitate reading and writing of the vehicle information.

Moreover, according to the present invention, when the IC tag is irradiated with ultraviolet rays while entirely covered with the resin, the UV setting resin hardens. Furthermore, the IC tag, together with the adhesive attached onto the body of the vehicle, is more firmly attached onto the body. Therefore, it becomes easy to fit the IC tag, and it is possible to obtain the effect to improve durability and reliability of the IC tag by means of covering with the resin while maintaining the IC tag in the readable and writable state.

Moreover, according to the present invention, the tag is mounted to the metal component while sealed inside the recessed portion by the resin. Additionally, the read/write signal to the tag is transmitted through the resin and is received by the tag. Therefore, the tag is reliably mounted to the metal. This is in contrast to the case of mounting the tag directly onto a surface of the metal component while maintaining the tag in the readable and writable state. Mounting the tag to the metal component while sealed inside the recessed portion by the resin improves durability and reliability of the IC tag.

Moreover, according to the present invention, the IC tag is mounted to the metal component so as to be placed on the signal-absorbing material inside the recessed portion and sealed thereon by filling the recessed portion with resin from above. Meanwhile, the read/write signal to the IC tag is transmitted through the resin and is received by the IC tag, and is absorbed by the signal-absorbing material. Therefore, a reflected wave of the radio wave attributable to the metal component is suppressed, and allowing a reader to read the article information reliably.

Selected examples of modes for carrying out the present invention are explained below by reference to embodiments of the present invention shown in the attached drawings. The above-mentioned object, other objects, characteristics and advantages of the present invention will become apparent form the detailed description of the embodiment of the invention presented below in conjunction with the attached drawings.

### BRIEF DESCRIPTION OF THE DRAWINGS

FIG. 1 is a left side view of a motorcycle showing an IC tag mounted to a metal surface in each of several possible locations, including the wheel rim, the head pipe, the vehicle body frame, and the engine head.

FIG. 2 is a perspective view of an isolated motorcycle wheel rim showing the recessed portion formed in the wheel rim rim.

FIG. 3 is a front cross-sectional view of the wheel rim of FIG. 2 showing three of the possible locations for positioning the recessed portion.

FIG. 4 is an enlarged partial sectional view of a recessed portion showing the IC tag positioned on high permeability magnetic material within the recessed portion, and completely covered and sealed by adhesive resin.

FIG. 5 is a top view of a main frame of a motorcycle showing a recessed portion formed on an outward facing portion of the head pipe and on an outward facing portion of the vehicle frame.

FIG. 6 is a top view of a head pipe showing a recess formed in a lateral outside surface of the head pipe.

FIG. 7 is a sectional view of the head pipe of FIG. 6 showing a recess formed in a lateral outside surface of the head pipe.

FIG. 8 is an enlarged partial sectional view of a recessed portion of FIG. 7 showing the IC tag positioned on high permeability magnetic material within the recessed portion, and completely covered and sealed by adhesive resin.

FIG. 9 is a left side view of an engine showing a recessed portion formed in the engine head.

FIG. 10 is a cross-sectional view of the engine of FIG. 9 showing the recessed portion formed in the engine cover of the engine head.

FIG. 11 is a cross-sectional view of the IC tag mounted on a UV setting adhesive, wherein the UV setting adhesive is mounted to a surface of a resin component, and both the IC tag and UV setting adhesive are completely covered by a resin seal; and

FIG. 12 is a top plan view of the IC tag of FIG. 11.

### DETAILED DESCRIPTION OF THE INVENTION

The best modes currently contemplated for carrying out the present invention are described below.

Two selected exemplary embodiments of this invention will be described below, based on the appended drawings. Note that description of front, back, left and right directions in the following explanations correspond to the same directions in a vehicle.

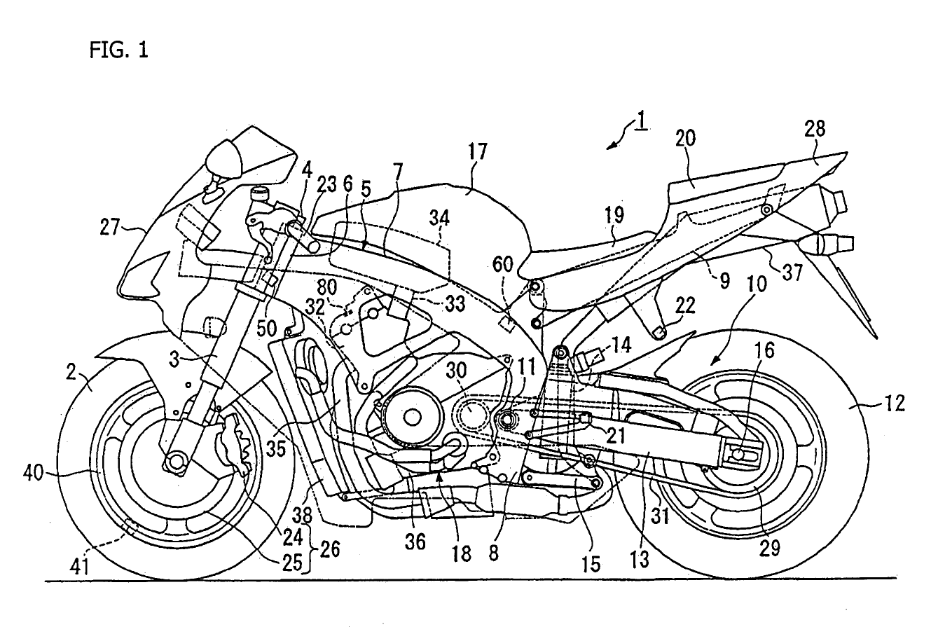

FIG. 1 shows a motorcycle 1 having an IC tag mounted to a metal surface in each of several possible locations, including the wheel rim rim 40, the head pipe 6, the vehicle body frame 7, and the engine head cover 81. As shown in FIG. 1, a front fork 3, rotatably supporting a front wheel 2 of the motorcycle 1, is pivotally and steerably supported by a head pipe 6 provided on a front end portion of a vehicle body frame 5 through a steering stem 4. A main frame 7 of the vehicle body frame 5 extends in an obliquely downward and backward direction from the head pipe 6, and a rear end portion thereof bends downward to contact a pivot plate 8. Moreover, a front end portion of a seat frame 9, extending in an obliquely upward and backward direction, is connected to a rear portion of the main frame 7.

A base end portion of a swing arm 13 is pivotally mounted to the pivot plate 8 through a pivot shaft 11, and a rear wheel 12 is rotatably supported on a tip end portion of this swing arm 13. An upper end portion of a shock absorber 14 is mounted above the base end side of the swing arm 13. A lower end portion of the shock absorber 14 is connected to the pivot plate 8 through a link mechanism 15 in a position lower than the pivot shaft 11.

A fuel tank 17 is mounted above the main frame 7, and a liquid-cooled inline four-cylinder engine 18 is mounted below the main frame 7, respectively. Moreover, a seat 19 for a driver and a pillion seat 20 for a pillion passenger are provided behind the fuel tank 17. Steps 21 for the driver are mounted behind the pivot plate 8, and steps 22 for the pillion passenger are mounted below the seat frame 9.

Handlebars 23 are mounted to an upper end portion of the front fork 3. Moreover, a brake caliper 24 is mounted to a lower end portion of the front fork 3 through a caliper bracket 42, and a brake disc 25 corresponding to the brake caliper 24 is mounted to a hub portion of the front wheel 2, thereby constituting a front disc brake (a disc brake) 26 according to this invention. Here, a rear disc brake having a similar configuration to the front disc brake 26 is provided on the right side of the rear wheel 12.

A front portion of the vehicle body of the motorcycle 1 is covered with a front cowl 27, and the vicinity of the seat frame 9 is covered with a rear cowl 28. A rear sprocket 29 is mounted to the left side of the rear wheel 12. A drive chain 31 is wound around both the rear sprocket 29 and a drive sprocket 30 provided on the rear left side of the engine 18, whereby driving force of the engine 18 is transmitted to the rear wheel 12.

Throttle bodies 33 corresponding to respective cylinders are connected to rear portions of cylinders 32 of the engine 18, and the respective throttle bodies 33 are connected to an air cleaner case 34 disposed between the main frame 7 and the fuel tank 17. Exhaust pipes 35 corresponding to the respective cylinders are connected to front portions of the cylinders 32, and the exhaust pipes 35 curve downward from near front wall portions of the cylinders 32, then bend upward behind the pivot plate 8 after passing below a crankcase 36, and are connected to a silencer 37 supported by the seat frame 9. A radiator 38 for cooling the engine 18 is provided in front of the exhaust pipes 35.

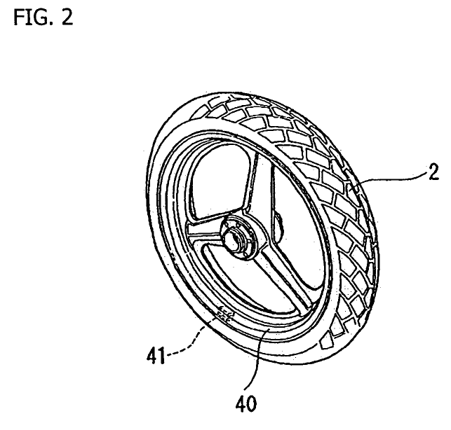

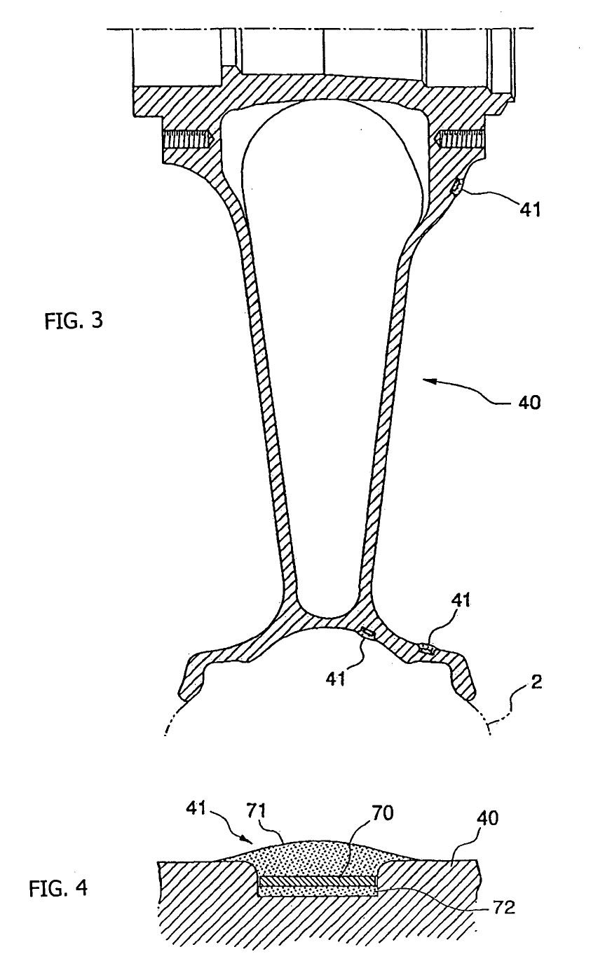

As shown in FIGS. 2-4 in a first application of the invention, a recessed portion 41, for receiving an IC tag 70, is formed on a wheel casting 40 of the motorcycle 1. The wheel casting 40 is an aluminum cast component that forms part of each of the front wheel 2 and the rear wheel 12. To be more precise, as shown in FIG. 3, the recessed portion 41 may be provided on a surface of the wheel rim 40, either facing a hub side, or on a surface facing the wheel side of the front wheel rim. In this way, it is possible to simultaneously check the air pressure of a front tire and to read data from the IC tag 70.

As shown in FIG. 4, the IC tag 70 and the recessed portion 41 are respectively shaped and dimensioned so that the IC tag 70 fits inside, and is housed in the recessed portion 41. For example, the recessed portion 41 may be processed into a shape such as a round hole or a square hole, depending on a manufacturer's preferences and also on the type of the metal selected (such as iron or aluminum). The IC tag 70 is also processed into suitable matching shape to correspond to the shape of the recessed portion 41.

The IC tag 70, thus processed, is received in the recessed portion 41, and is sealed therein by an adhesive resin 71 applied to the recessed portion 41 from above. As a result, the entire IC tag 70 is housed within the recessed portion 41, and is substantially completely covered by adhesive resin 71. In this way, the IC tag 70 may be placed on or adjacent a bottom surface of the recessed portion 41. The adhesive resin 71 is filled above the IC tag 70 inside the recessed portion 41, whereby the exposed portion of the IC tag 70 inside the recessed portion 41 is substantially completely covered. It is conceivable to use, for example, an UV setting adhesive or the like, for the adhesive resin 71. The UV setting resin cures and hardens after being irradiated by ultraviolet rays, and the IC tag 70 is more firmly attached onto the wheel rim 40 after curing of the resin 71. In this way, the IC tag 70 is mounted to the wheel rim 40 (the metal component) while sealed inside the recessed portion 41 by the resin. Therefore, the tag 70 is substantially protected from receiving a direct impact from the outside. Accordingly, the tag is reliably mounted to the metal, in contrast to the case of mounting the tag directly onto the surface of the metal component.

Alternatively, instead of the adhesive resin 71, it is possible to seal the entire IC tag 70 completely by use of urethane coating (protective resin). In this way, a surface of the adhesive resin 71 exposed above the recessed portion 41 is covered with the urethane coating, similar to the wheel rim 40, whereby the recessed portion 41 becomes less recognizable in appearance. Therefore, in contrast to the case of mounting the tag directly onto the surface of the metal component, there is little or no danger of the tag being peeled off artificially. Hence, the durability and reliability of the tag is improved.

When a read/write signal is transmitted from a reader to the IC tag 70 in this state, the read/write signal to the IC tag 70 transmits readily inwardly through the adhesive resin 71, and reaches the IC tag 70. The IC tag 70 receives this read/write signal, performs writing in an embedded memory or reading information about an article written in the memory, and then transmits the information thus read out on a radio wave. Additionally, the read/write signal from the tag 70 to the reader transmits outwardly through the adhesive resin 71, and is received by the reader, whereby the information about the article stored in the IC tag 70 is read out.

Therefore, in contrast to the case of mounting the tag directly onto the surface of the metal component, it is possible to achieve writing and reading of the information about the article using radio transmission while the tag is securely mounted in the recessed portion of the metal component.

Some difficulty can arise where the read/write signal, transmitted from the reader to the IC tag 70, passes through the IC tag 70 and reaches the rear side of the IC tag 70 as well. Accordingly, the radio wave (the read/write signal) may be reflected by the wheel rim 40, which is the metal component, and this reflected wave may also be received by the reader. When the reader receives this reflected wave, together with a data signal transmitted by the IC tag 70, a reading error may occur, due to this reflected wave.

Therefore, to prevent such a reading error, a signal-absorbing material 72 may be provided in the recessed portion 41, between the IC tag 70 and the metal component. Specifically, in the embodiment of FIGS. 2-4, the a signal-absorbing material 72 is placed on the bottom surface of the recessed portion 41, before the IC tag 70 is placed therein. Then, the IC tag 70 is placed onto the signal-absorbing material 72 and is sealed thereon by using the adhesive resin 71 to substantially completely cover the entire IC tag 70, as discussed above. As one non-limiting example of a suitable signal-absorbing material 72, a glass-epoxy composite may be used.

In this way, the IC tag 70 is placed on the signal-absorbing material 72 inside the recessed portion 41, and is mounted to the metal component in the state sealed by the resin from above. Meanwhile, the read/write signal to the IC tag 70 transmits inwardly through the resin, and is received by the IC tag 70 and absorbed by the signal-absorbing material, to the extent that the signal passes through the tag 70. Therefore, it is possible to effectively suppress the reflected radio wave, attributable to the metal component, and to reliably read the article information.

Optionally, other metal components within the vehicle can be used as suitable alternative structures to the wheel rim 40, on which IC tag 70 is mounted. Examples of suitable alternative metal components include the head pipe 6, the main frame 7, and the engine 32.

For example, in a second application of the inventive tag arrangement, as shown at the right side of FIG. 5, a recessed portion 60 may be provided on the left side of the main frame 7, at a location exposed to the outside of the vehicle. Then, the signal-absorbing material 72 and the IC tag 70 are placed within recessed portion 60 and sealed therein by the adhesive resin 71. The adhesive resin 71 may be applied from above to substantially completely cover the entire IC tag 70. In this way, it is easy to read the data in the case of a twin-tube frame or the like, because the frame is exposed to the outside.

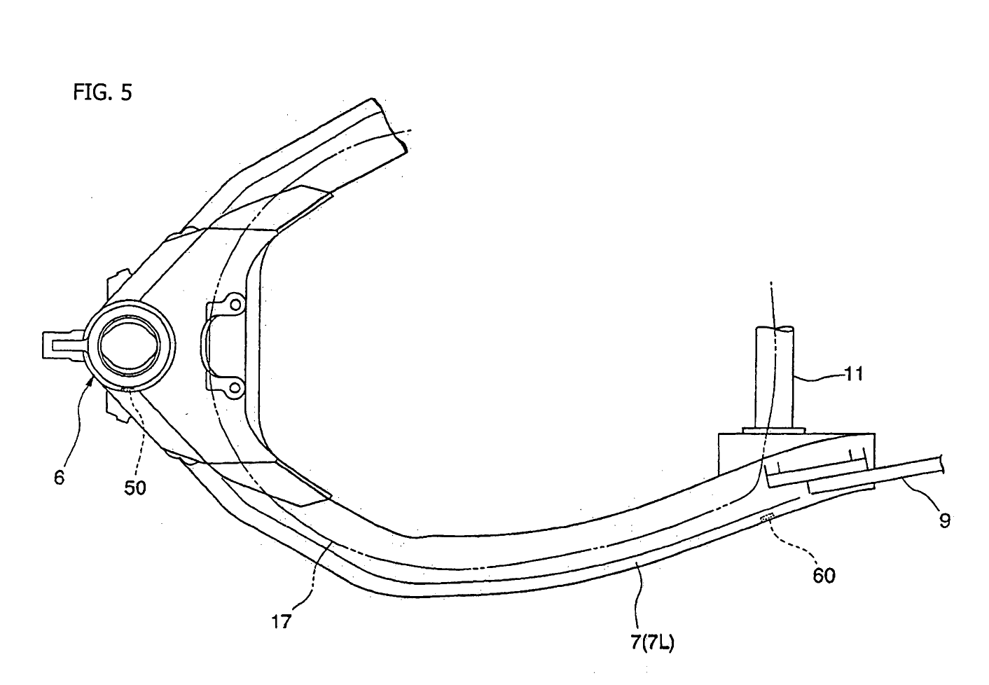

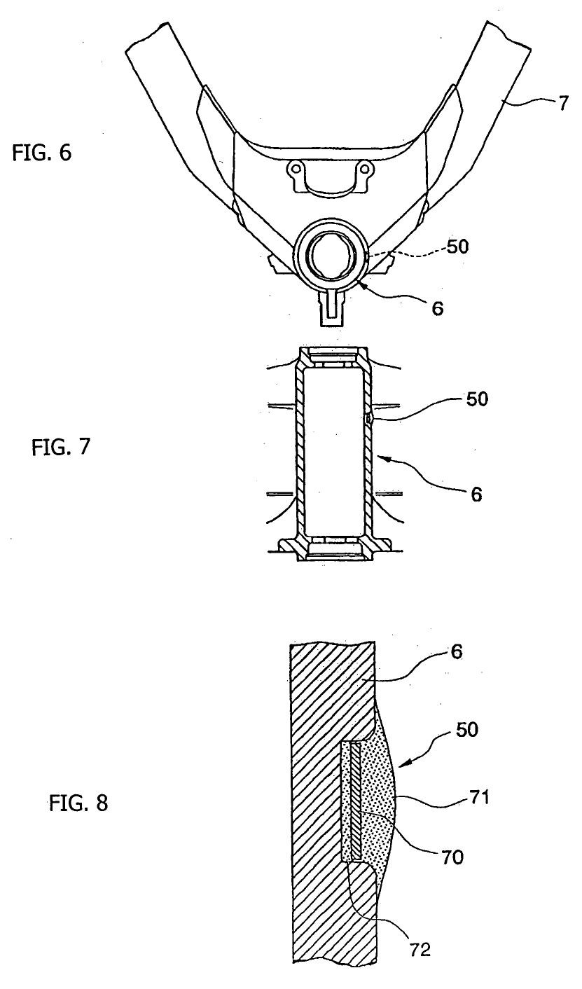

Similarly, in a third application of the inventive tag arrangement, as shown in FIGS. 6 and 7, a recessed portion 50 may be provided on an exterior surface of the head pipe 6, so as to be exposed to the outside environment. The signal-absorbing material 72 and the IC tag are placed within the recessed portion 50, and sealed therein by the adhesive resin 71. Adhesive resin 71 is applied from above to substantially completely cover the entire IC tag 70 (FIG. 8).

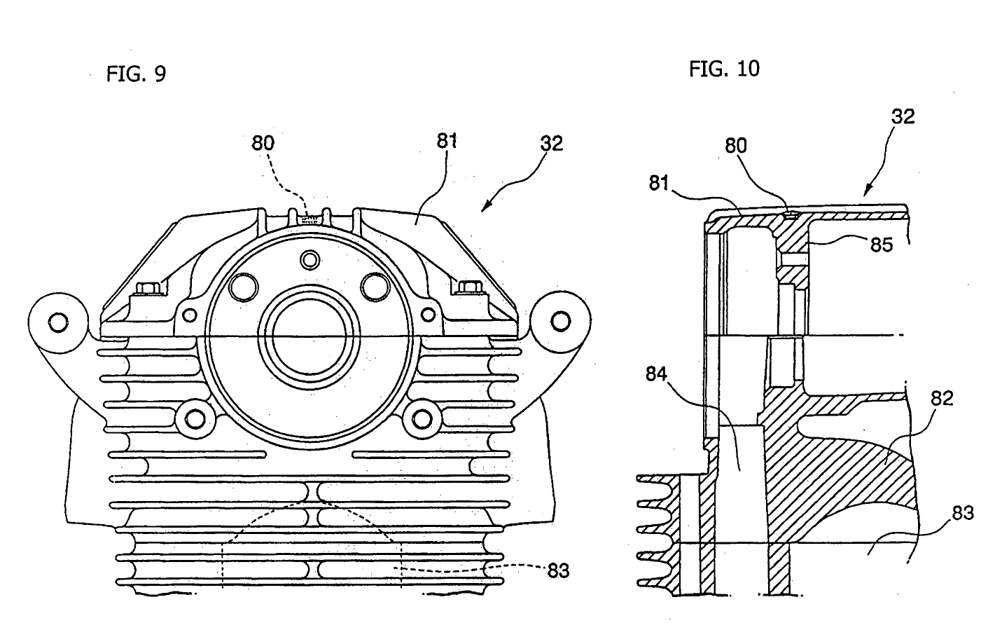

Moreover, in a fourth application of the inventive tag arrangement, as shown in FIGS. 9 and 10, a recessed portion 80 may be provided on an engine cover at the top of the engine 32. The signal-absorbing material 72 and the IC tag 70 are placed within recessed portion 80 and sealed therein by the adhesive resin 71. Adhesive resin 71 is applied from above to substantially completely cover the entire IC tag 70. In FIG. 10, a cam chain case 84 is provided beside a cylinder head 82 of a cylinder 83, and the recessed portion 80 is provided in a position above the cam holder portion 85 and on an upper surface of an engine cover 81. The engine cover 81 is exposed to the outside.

In this way, similar to the case of the wheel rim 40, it is possible to suppress the reflected wave of the radio wave attributable to the metal construction of the head pipe 6, the main frame 7 or the engine 32, and to read the article information reliably. In addition, since the IC tag 70 is buried in a recess, particularly for the case wherein it is buried in the head cover above the engine, it is accordingly easy to read the data and, in case of a trouble, it is easy to gain access to the tag to perform maintenance simply by detaching the head cover.

Further, in a fifth application of the inventive tag arrangement, a recessed portion 80 may be provided on a tandem step bracket on the left side of the vehicle. By the configuration described above, it becomes easy to read the data because a tandem step is exposed to the outside of the vehicle.

Note that concrete descriptions of the article and the specific data configuration of the article information stored on the ID tag 70 were not specified in the above-described embodiment. Although a motorcycle is used to illustrate the invention, other transportation machines, including but not limited to a passenger automobile, a bus, a truck, a motor-assisted bicycle, a bicycle or a four-wheel buggy, an airplane, a ship, a boat, a yacht, a personal watercraft, or a marine bike would each respectively benefit from the invention.

In addition, as regards the specific data configuration of the article information stored on the IC tag 70, it is conceivable to write a piece or a combination of multiple pieces of identification information about the motorcycle 1, the wheel rim 40, or the like constituting the article (such as a vehicle ID or a wheel ID). In this way, by writing the identification information about the article to the IC tag 70, it is possible to identify the individual article to which the IC tag 70 is attached.

Moreover, a person can confirm the information outputted from the IC tag 70 by linking at least any of registration information of the article and history information of the article to the identification information of the article, and by writing the foregoing information in a database of an external computer system or in the memory in the IC tag 70, and by outputting the registration information or the history information concerning the individual article based on the identification information. The registration information of the article may include, but is not limited to car registration information of the vehicle, information concerning an owner including a name, an address, an electronic mail address, or the like. The history information of the vehicle may include, but is not limited to, history information including production, registration, a change of ownership, refueling, maintenance records, a check, a repair, part change, export, import, deletion of registration, or the like.

Therefore, in contrast to the case of simply mounting the IC tag 70 onto the surface of the metal component, it is possible to improve traceablity of the individual article while retaining the durability of the IC tag 70 for a long period as in this embodiment.

Next, a second embodiment of this invention will be described based on drawings.

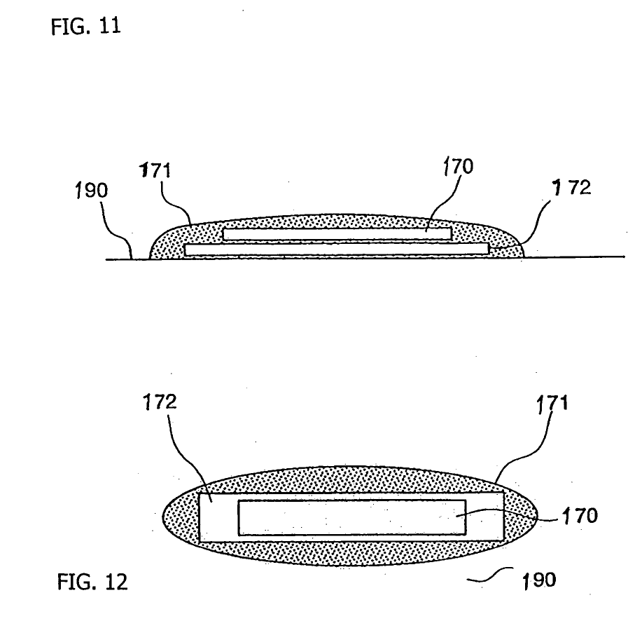

FIG. 11 and FIG. 12 show an IC tag 170 according to a second embodiment hereof, mounted to a resin surface. In FIG. 11, the UV setting resin adhesive base 172, serving as the base of the IC tag 170, is attached onto a resin component 190. The resin component 190 forms part of a body of a vehicle. The IC tag 170 is placed on the UV setting resin adhesive base 172 on the opposite side to the surface adhered to the resin component 190. Moreover, by means of lapping the UV setting resin adhesive (a seal) 171 over the IC tag 170 and the UV setting resin adhesive base 172, the UV setting resin adhesive (the seal) 171 seals the IC tag as well as the UV setting resin adhesive base 172 so as to cover them completely.

Here, in order to easily cover the entire IC tag, it is preferable to form the IC tag 170 in an appropriate size to be disposed inside the peripheral edges of the UV setting resin adhesive base 172 without protruding beyond the peripheral edges of the UV setting resin adhesive base 172 as shown in FIG. 12. Moreover, to enhance adhesion strength of the entire IC tag, the UV setting resin adhesive (the seal) 171 is hardened in a circular shape or an oval shape, and is then adhered to the resin component 190.

In this way, the IC tag 170 is set to the state entirely covered with the UV setting resin adhesive (the seal) 171 together with the UV setting resin adhesive (the base) 172 attached onto the resin component 190. Meanwhile, corner portions of the IC tag 170 are covered, and the UV setting resin adhesive (the seal) 171 is set to the state not including corner portions similarly. Moreover, when ultraviolet rays are irradiated on the IC tag 170, as well as the UV setting resin adhesive (the base) 172 attached onto the resin component 190 in the state entirely covered with the UV setting resin adhesive (the seal) 171, the UV setting resin adhesive (the seal) 171 hardens and the IC tag 170 is set to the state more firmly adhered onto the resin component 190.

In this embodiment, the read/write signal (an electromagnetic wave) to the IC tag 170 transmits through the UV setting resin adhesive (the seal) 171 and is received by the IC tag 170. Therefore, by covering the IC tag 170 with the UV setting resin adhesive (the seal) 171 while maintaining a readable and writable state of the IC tag 170, it is possible to enhance adhesion strength and to prevent the IC tag 170 from being peeled off due to an applied force at corner portions thereof. Accordingly, the durability and reliability of the IC tag 170 is improved.

Moreover, the IC tag 170 receives the read/write signal transmitted from the reader for the IC tag 170, and performs writing in the memory inside the IC tag 170 or reading given vehicle information written in the memory, and transmits the vehicle information thus read out on a radio wave. Therefore, it is possible to achieve reading and writing of the vehicle information by use of radio transmission. In particular, it is easy to mount ID tag 170 to a lower part of a body of a two-wheel vehicle or a four-wheel vehicle, or the like, and to facilitate reading and writing of the vehicle information.

While a working example of the present invention has been described above, the present invention is not limited to the working example described above, but various design alterations may be carried out without departing from the present invention as set forth in the claims.

1. A method of mounting a tag to an article, wherein the tag comprises stored information about the article, and wherein the article comprises at least one metal component having a recess formed therein and opening toward the outside of the metal component, said method comprising the steps of:
a) placing the tag in the recess of the metal component;
b) applying a resin over the tag to seal therein.

2. The method of mounting a tag to an article according to claim 1, further comprising the steps of:
positioning a high-permeability magnetic material in the recessed portion before placing the tag therein;
placing the tag on the high-permeability magnetic material;
wherein the tag is sealed within the recessed portion by the resin, during the curing step, such that the resin covers the tag.

3. The method of mounting a tag to an article according to claim 2, wherein the high-permeability magnetic material comprises a glass-epoxy composite.

4. The method of mounting a tag to an article according to claim 2, wherein the resin is curable upon exposure to ultraviolet light, and wherein the curing step comprises applying ultraviolet light to the resin.

5. The method of mounting a tag to an article according to claim 1, wherein the resin is curable upon exposure to ultraviolet light, and wherein the curing step comprises applying ultraviolet light to the resin.

6. The method of mounting a tag to an article according to claim 1, wherein the article comprises a vehicle, wherein the metal component comprises a wheel rim, and wherein the recessed portion is provided on a surface of the wheel rim which is oriented toward a hub.

7. The method of mounting a tag to an article according to claim 1, wherein the article comprises a vehicle, wherein the metal component comprises a main frame of the vehicle, and wherein the recessed portion is provided on a side of a main frame that is exposed to the outside of the vehicle.

8. The method of mounting a tag to an article according to claim 1, wherein the article comprises a vehicle, wherein the metal component comprises a tandem step bracket, and wherein the recessed portion is provided on the tandem step bracket on a side of the vehicle.

9. The method of mounting a tag to an article according to claim 1, wherein the article comprises a vehicle, wherein the metal component comprises a head cover for a vehicle engine mounted on the vehicle, and wherein the recessed portion is provided on the head cover for the vehicle engine.

10. The method of mounting a tag to an article according to claim 1, further comprising a step of positioning a radio wave-absorbing material in the recess between the tag and the metal component.

11. The method of mounting a tag to an article according to claim 1, wherein the tag is covered with a urethane coating.

12. A vehicle comprising a vehicle body and an identification tag mounted thereon, wherein the tag comprises stored vehicle information, wherein the tag is placed on an adhesive pad which is attached onto a body of the vehicle, and wherein the tag is sealed to the body of the vehicle by a resin which substantially covers both the tag and the adhesive pad.

13. The vehicle according to claim 12, wherein the resin is curable upon exposure to ultraviolet light.

14. The vehicle according to claim 12, wherein the body of the vehicle comprises resin.

15. The vehicle according to claim 12 wherein the tag and adhesive pad are constructed and arranged such that the tag does not extend beyond outer peripheral edges of the adhesive pad.

16. A tag mounting method for mounting a tag to an article, wherein the tag comprises integrated circuits and memory storage, and wherein the article comprises plural components, the tag mounting method comprising the steps of:
placing the tag on an outer surface of a selected one of said components; and
fixing the tag to the outer surface of the selected component using a resin, so as to substantially cover the tag with the resin.

17. The tag mounting method of claim 16, wherein the selected component comprises a metal.

18. The tag mounting method of claim 17, wherein the selected component has a recess formed therein which opens to the outside of the article, and wherein the tag is received within the recess such that when the tag is covered with resin, the resin surface is generally flush with the outer surface of the component adjacent the recess.

19. The tag mounting method of claim 18, further comprising a step of placing a radio wave-absorbing material into the recess before placing the tag therein.

20. The tag mounting method of claim 16, wherein the selected component comprises a plastic material, wherein the tag is mounted on a UV-curable resin adhesive base which is positioned on the selected component, and wherein both the tag and the resin adhesive base are substantially covered with resin.
